(19) United States
(12) Patent Application Publication
(10) Pub. No.: US 2016/0159176 A1
(43) Pub. Date: Jun. 9, 2016

(54) HITCH DIRECTING SYSTEM

(71) Applicants: Bryan McCormick, Mesa, AZ (US); Wesley Filleman, Gilbert, AZ (US)

(72) Inventors: Bryan McCormick, Mesa, AZ (US); Wesley Filleman, Gilbert, AZ (US)

(21) Appl. No.: 14/959,920

(22) Filed: Dec. 4, 2015

Related U.S. Application Data
(60) Provisional application No. 62/087,383, filed on Dec. 4, 2014.

(51) Int. Cl. B60D 1/36; G01D 5/34; G01B 11/27

(52) U.S. Cl. CPC B60D 1/36; G01B 11/272; G01D 5/34

(57) ABSTRACT

A hitch directing system is provided. The hitch directing system comprises a sensor bar having two or more LED lights and an optical sensor having a processor, a memory and electronic devices for operating the optical sensor. The optical sensor further comprises firmware stored in the memory to provide instructions to the processor of the optical sensor to operate the optical sensor and locate the position of the LED lights of the sensor bar with respect to the optical sensor. The system further comprises a computing device operating software, wherein the software interprets the location of the optical sensor with respect to the LEDs of the sensor bar, and provides a graphical representation of the location and the alignment of a hitch with respect to a tongue of a trailer.

### CROSS REFERENCE TO RELATED APPLICATION

This application claims priority to U.S. Provisional Patent Application entitled “HITCH DIRECTING SYSTEM”, Ser. No. 62/087,383, filed Dec. 4, 2014, the disclosure of which is hereby incorporated entirely herein by reference.

### BACKGROUND OF THE INVENTION

1. Technical Field

This invention relates generally to a hitch directing system and more particularly to a hitch directing system utilizing a light bar, a sensor and an application to direct a vehicle to properly align a hitch ball with a hitch.

2. State of the Art

The art of backing up a vehicle in order to attach the hitch of the vehicle to a tongue of a trailer or the like. A commonly used hitch includes a ball mount. A use is required to align the ball mount of the hitch with the tongue of a trailer in order to engage the tongue with the ball mount and lock the engagement in order to place the vehicle and the trailer in a condition to tow the trailer. Commonly, the driver of the vehicle will enlist the assistance of a second person to direct the backing of the vehicle and there ultimately the aligning of the ball mount with the tongue of the trailer.

Other inventions have been developed that utilize certain sensors or electronic devices to align the ball mount with the tongue. These systems lack the ability to use a light bar and optical sensors to produce three dimensional positioning and relay the positioning to the driver in order for a single driver to properly align the hitch with the tongue of the trailer. Further, the systems are lacking in compatibility with any trailer and tow hitch combination and particularly to apply this after-market to any type of tow hitch system.

Accordingly, there is a need for an improved hitch directing system.

### DISCLOSURE OF THE INVENTION

The present invention relates to a hitch directing system having a sensor bar, an optical sensor and a computing device operating software application, wherein the computing device is in communication with the optical sensor. The computing device performs operations to determine the position of the hitch in response to determining the position of the optical sensor with respect to the sensor bar.

An embodiment includes A hitch directing system comprising: a reflecting member comprising at least two reflectors spaced apart a predetermined distance, the reflecting member coupled to a trailer; an optical sensor unit comprising an infrared sensor and a plurality of infrared emitters, the optical sensor unit coupled to a vehicle; and a computing device operating a software application, the computing device in communication with the optical sensor unit, wherein: the plurality of infrared emitters of the optical sensor unit emits infrared light toward the reflecting members and the infrared sensor senses the reflected infrared light from the reflecting member; position data generated in response to the infrared sensor sensing the reflected infrared light from the reflecting member, wherein the position data is communicated from the optical sensor unit to the computing device; and the computing device interprets the location of the optical sensor unit with respect to the reflecting member in response to operating the software application interpreting the position data, and provides alignment of a hitch of the vehicle with respect to a tongue of the trailer.

Another embodiment includes a hitch directing system comprising: a reflecting member comprising at least two reflectors spaced apart a predetermined distance, the reflecting member coupled to a trailer; an optical sensor unit comprising an infrared sensor and a plurality of infrared emitters, the optical sensor unit coupled to a vehicle; a relay unit; and a computing device operating a software application, the relay unit is in communication with the computing device and with the optical sensor unit, wherein: the plurality of infrared emitters of the optical sensor unit emits infrared light toward the reflecting members and the infrared sensor senses the reflected infrared light from the reflecting member; position data generated in response to the infrared sensor sensing the reflected infrared light from the reflecting member, wherein the position data is communicated from the optical sensor unit to the computing device through the relay unit; and the computing device interprets the location of the optical sensor unit with respect to the reflecting member in response to operating the software application interpreting the position data, and provides alignment of a hitch of the vehicle with respect to a tongue of the trailer.

Yet another embodiment includes a method of operating a hitch directing system comprising: emitting an infrared light from an optical sensing unit on a vehicle to a reflecting member on a trailer; sensing reflected infrared light from the reflecting member by an infrared sensor of the optical sensing unit; creating position data by the optical sending unit in response to sensing the reflected infrared light by the infrared sensor; communicating the position data to a computing device; and aligning a hitch of the vehicle with a tongue of the trailer in response to interpreting the position data by the computing device.

The foregoing and other features and advantages of the present invention will be apparent from the following more detailed description of the particular embodiments of the invention, as illustrated in the accompanying drawings.

### BRIEF DESCRIPTION OF THE DRAWINGS

FIG. 1 is a perspective view of an optical sensor unit of a hitch directing system, in accordance with embodiments;

FIG. 2 is a perspective view of a relay unit of a hitch directing system, in accordance with embodiments;

FIG. 3 is a perspective view of an optical sensor coupled to a rear of a vehicle, in accordance with embodiments;

FIG. 4 is a perspective view of an optical sensor coupled to a vehicle, in accordance with embodiments;

FIG. 5 is a side view of a hitch directing system, in accordance with embodiments; and

FIG. 6 is a schematic view of a hitch directing system, in accordance with embodiments.

### DETAILED DESCRIPTION OF EMBODIMENTS OF THE INVENTION

As discussed above, embodiments of the present invention relate to a hitch directing system having a sensor bar, an optical sensor and a computing device operating software application, wherein the computing device is in communication with the optical sensor. The computing device performs operations to determine the position of the hitch in response to determining the position of the optical sensor with respect to the sensor bar.

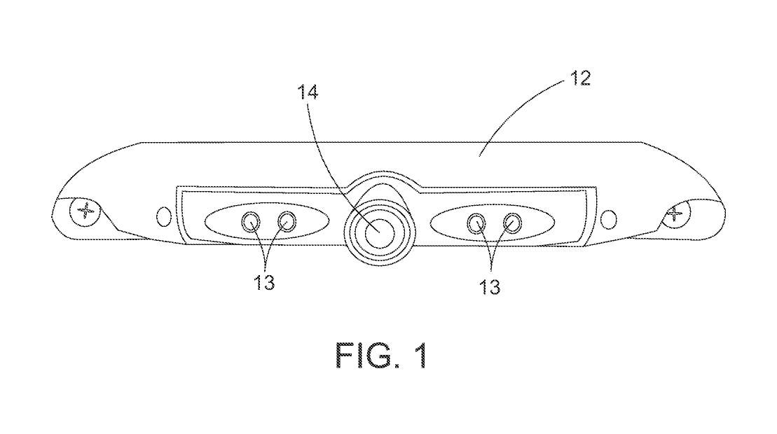

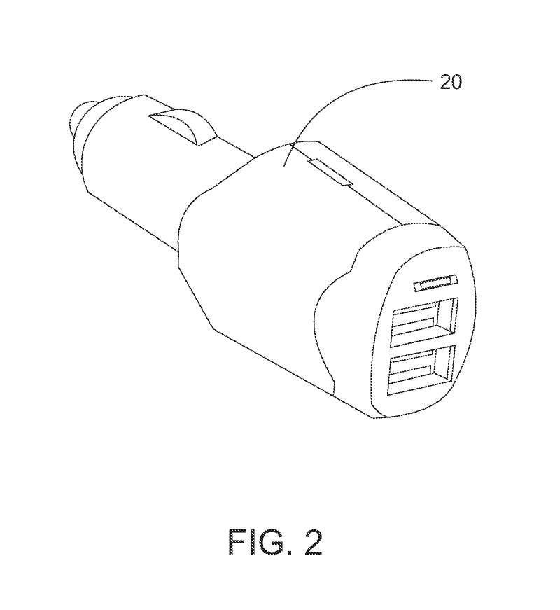

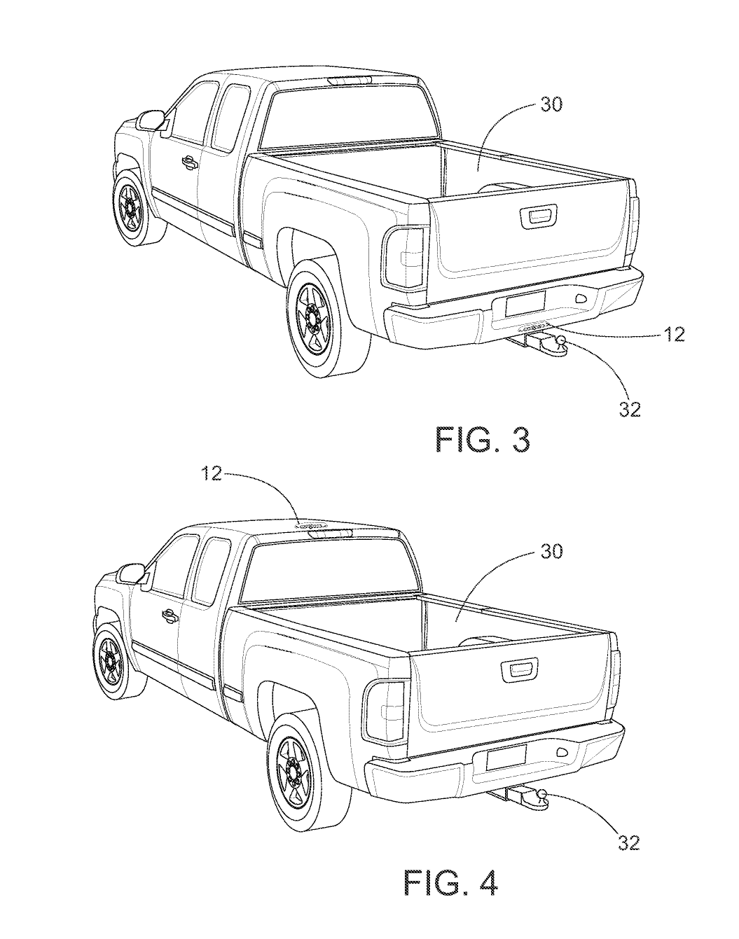

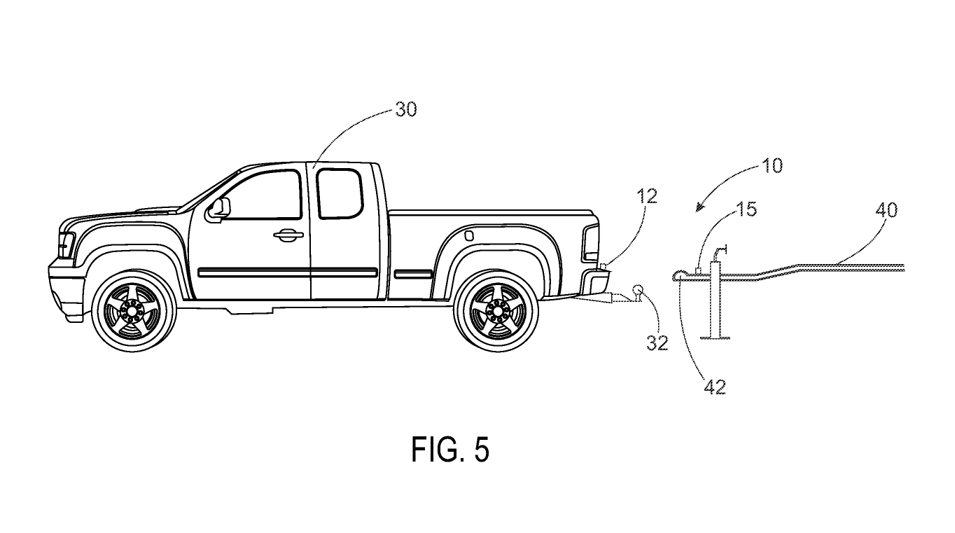

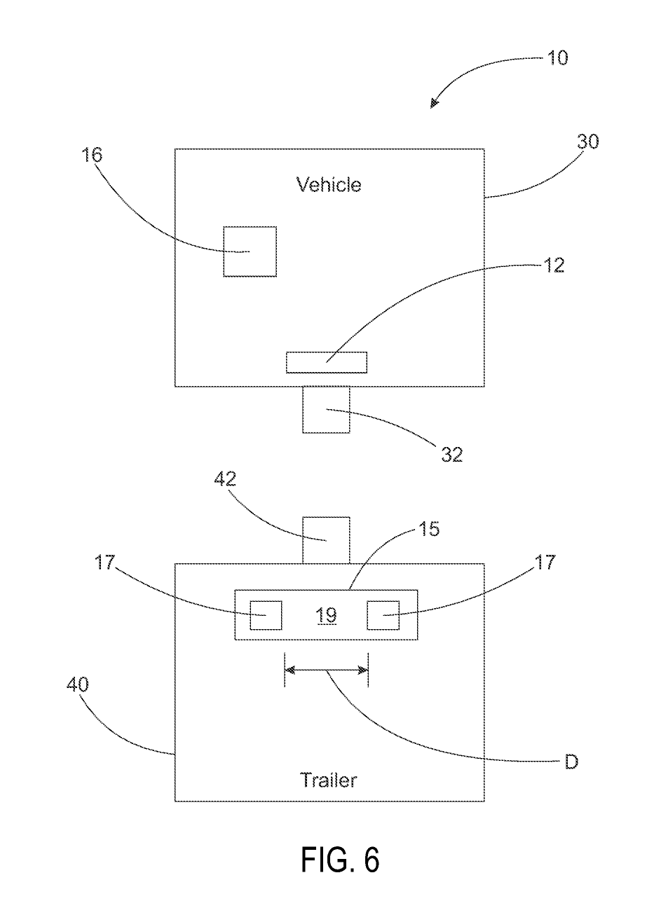

Referring to the drawings, FIGS. 1-6 depict a hitch directing system 10 according to embodiments of the present invention. The system 10 includes an optical sensor unit 12 with a plurality of infrared emitters 13, an infrared sensor 14, a reflecting member 15, and a computing device 16. The reflecting member 15 may be coupled to an object, such as a trailer or the like. The reflecting member 15 may include at least two reflectors 17 that have a predetermined distance D between them. The reflectors 17 may be coupled to a substrate 19, wherein the substrate 19 maintains the at least two reflectors 17 the predetermined distance D apart. The optical sensor unit 12 may be coupled to a vehicle 30, such as the back of the vehicle 30. The computing device 16 may be any computing device, such as, but not limited to, a smartphone, a tablet, an onboard computing device of the vehicle, a laptop and any other type of computing device. The computing device 16 may include a processor and a memory for storing a software application, the software application providing instructions for operation of the system. The computing device 16 may also include a database stored in the memory, wherein the database may retain initial locations of the optical sensor unit 12 with respect to the reflecting member 14.

The optical sensor unit 12 may be coupled to the vehicle 30 and is in view of the reflecting member 15 and particularly in view of the infrared emitters 13 of the sensor bar. In embodiments, the infrared emitters 13 may be infrared LEDs or any type of infrared emitting elements or components. The term “in view” means at minimum that the optical sensor unit 12 can sense and locate each infrared emitter 13 of the optical sensor unit 12. The optical sensor unit 12 may include firmware, or other form of a software product, wherein the firmware provides instructions to a processor from a memory of the optical sensor unit 12 to operate the infrared sensor 14 and locate the position of the infrared emitters 13 of the sensor unit 12 with respect to the reflecting member 14. The firmware of the optical sensor unit 12 may provide two-dimension position information to the computing device 16, wherein the computing device 16 performs calculations to determine the location in two dimensions.

The optical sensor unit 12 may establish a communication link with the computing device 16. This may be a wireless communication, such as WiFi or Bluetooth communication. Further, it is contemplated that some embodiments may include a wired communication between the optical sensor unit 12 and the computing device 16. The communication link allows for the computing device 14 to receive position data from the optical sensor unit 12. The computing device 16 obtains this information in response to the processor executing instructions of the software application stored in the memory of the computing device 16. In some embodiments, executing the instructions of the software establishes an open communication link between the optical sensor unit 12 and the computing device 16, wherein the optical sensor unit 12 continuously sends position data to the computing device 16. The computing device 16 continuously processes the position data and compares it with the initial position data stored in the database of the memory of the computing device 16. The computing device 16 may then provide a graphical display of a hitch 18 and a tongue 20. In response to the processor comparing the alignment data from the optical sensor unit 12 with the initial position data, the computing device may provide a representation of the location of the hitch with respect to the tongue.

In some embodiments, the communication link may be accomplished by use of a relay unit 20, wherein the relay unit 20 is in communication with the computing device 16 and with the optical sensor unit 12. This allows position data to be communicated from the optical sensor unit 12 to the computing device 16 through the relay unit 20. In embodiments, the relay unit 20 the relay unit may comprise a Bluetooth module and a radio transceiver. Further, the relay unit 20 may be powered from the vehicle 30.

The computing device continuously processes the optical sensor unit's 12 reported position in two-dimensional space and calculates a relative current position in three dimensions from the reflector member 15 based on the initial saved home location. The computing device 16 uses the known fixed distance between the reflectors 17, known physical distance between the installed reflecting member 15 and the trailer tongue 42, and the known home position of the reflectors 17 when the trailer tongue 42 and hitch 32 are connected in order to triangulate the actual current position of the hitch or ball 32 relative to the trailer tongue 42 in three-dimensional space. As the computing device 16 continuously receives updated reflector member 15 two-dimensional location information from the optical sensor unit 12, the computing device 16 calculates the relative position with the above triangulation method and updates the user facing display with near real-time audio, video, and other multimedia updates as the user approaches the hitch with the ball of the vehicle for purposes of alignment.

The computing device 16 may, in response to the position data comparison with the initial position data, notify the driver of the vehicle to turn the steering wheel a particular direction to properly align the hitch 32 with the tongue 42. This notification may be visual, audio or a combination thereof. The continuous determination of proper alignment of the based on the position data and the initial position data allows the driver to back the vehicle into the proper location and alignment to properly engage the tongue 42 with the hitch 32.

In some embodiments, the system 10 will also notify the driver if the vertical alignment is off In particular the system 10 may notify the driver if the hitch is higher than the tongue of the trailer. This allows the driver from forcing the hitch into contact with the tongue and causing damage to the trailer, the vehicle or both.

Some embodiments include a method of operating a hitch directing system comprising emitting an infrared light from an optical sensing unit on a vehicle to a reflecting member on a trailer; sensing reflected infrared light from the reflecting member by an infrared sensor of the optical sensing unit; creating position data by the optical sending unit in response to sensing the reflected infrared light by the infrared sensor; communicating the position data to a computing device; and aligning a hitch of the vehicle with a tongue of the trailer in response to interpreting the position data by the computing device.

The method further comprises determining a home position, wherein home position is determined in response to triangulating position of a ball of the hitch relative to a tongue of the trailer in three-dimensional space by triangulation of the reflected infrared light with the infrared sensor when the ball of the hitch is connected to the tongue.

The method further comprises continuously processing the position of the optical sensor unit with respect to the reflecting member in two-dimensional space and calculating a relative current position in three dimensions based on the home position. The method includes comprising guiding the vehicle to align the hitch with the tongue, and displaying a graphical representation of location of the hitch with respect to the tongue on a display of the computing device.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A hitch directing system comprising:
a reflecting member comprising at least two reflectors spaced apart a predetermined distance, the reflecting member coupled to a trailer;
an optical sensor unit comprising an infrared sensor and a plurality of infrared emitters, the optical sensor unit coupled to a vehicle; and
a computing device operating a software application, the computing device in communication with the optical sensor unit, wherein:
the plurality of infrared emitters of the optical sensor unit emits infrared light toward the reflecting members and the infrared sensor senses the reflected infrared light from the reflecting member;
position data generated in response to the infrared sensor sensing the reflected infrared light from the reflecting member, wherein the position data is communicated from the optical sensor unit to the computing device; and
the computing device interprets the location of the optical sensor unit with respect to the reflecting member in response to operating the software application interpreting the position data, and provides alignment of a hitch of the vehicle with respect to a tongue of the trailer.

2. The system of claim 1, wherein the reflecting member further comprises a substrate with the at least two reflectors coupled to the substrate the predetermined distance, wherein the substrate maintains the at least two reflectors the predetermined distance.

3. The system of claim 1, wherein the computing device is a mobile computing device.

4. The system of claim 1, wherein the computing device and the optical sensor unit are in wireless communication with each other.

5. The system of claim 1, wherein the computing device comprises a display, wherein the computing device displays a graphical representation of location of the hitch with respect to the tongue.

6. The system of claim 1, wherein the plurality of infrared emitters is a plurality of infrared LEDs.

7. A hitch directing system comprising:
a reflecting member comprising at least two reflectors spaced apart a predetermined distance, the reflecting member coupled to a trailer;
an optical sensor unit comprising an infrared sensor and a plurality of infrared emitters, the optical sensor unit coupled to a vehicle;
a relay unit; and
a computing device operating a software application, the relay unit is in communication with the computing device and with the optical sensor unit, wherein:
the plurality of infrared emitters of the optical sensor unit emits infrared light toward the reflecting members and the infrared sensor senses the reflected infrared light from the reflecting member;
position data generated in response to the infrared sensor sensing the reflected infrared light from the reflecting member, wherein the position data is communicated from the optical sensor unit to the computing device through the relay unit; and
the computing device interprets the location of the optical sensor unit with respect to the reflecting member in response to operating the software application interpreting the position data, and provides alignment of a hitch of the vehicle with respect to a tongue of the trailer.

8. The system of claim 7, wherein the reflecting member further comprises a substrate with the at least two reflectors coupled to the substrate the predetermined distance, wherein the substrate maintains the at least two reflectors the predetermined distance.

9. The system of claim 7, wherein the computing device is a mobile computing device.

10. The system of claim 7, wherein the computing device and the optical sensor unit are in wireless communication with each other.

11. The system of claim 7, wherein the computing device comprises a display, wherein the computing device displays a graphical representation of location of the hitch with respect to the tongue.

12. The system of claim 7, wherein the plurality of infrared emitters is a plurality of infrared LEDs.

13. The system of claim 7, wherein the relay unit comprises a Bluetooth module and a radio transceiver.

14. The system of claim 13, wherein the relay unit is powered from the vehicle.

15. A method of operating a hitch directing system comprising:
emitting an infrared light from an optical sensing unit on a vehicle to a reflecting member on a trailer;
sensing reflected infrared light from the reflecting member by an infrared sensor of the optical sensing unit;
creating position data by the optical sending unit in response to sensing the reflected infrared light by the infrared sensor;
communicating the position data to a computing device; and
aligning a hitch of the vehicle with a tongue of the trailer in response to interpreting the position data by the computing device.

16. The method of claim 15, further comprising determining a home position.

17. The system of claim 16, wherein home position is determined in response to triangulating position of a ball of the hitch relative to a tongue of the trailer in three-dimensional space by triangulation of the reflected infrared light with the infrared sensor when the ball of the hitch is connected to the tongue.

18. The system of claim 17, further comprising continuously processing the position of the optical sensor unit with respect to the reflecting member in two-dimensional space and calculating a relative current position in three dimensions based on the home position.

19. The system of claim 18, further comprising guiding the vehicle to align the hitch with the tongue.

20. The system of claim 15, further comprising displaying a graphical representation of location of the hitch with respect to the tongue on a display of the computing device.
